(19) United States
(12) Patent Application Publication
(10) Pub. No.: US 2007/0289557 A1
(43) Pub. Date: Dec. 20, 2007

(54) ANIMAL GARMENT

(76) Inventor: Janice Gerdes, Melba, ID (US)

Correspondence Address: DYKAS, SHAVER & NIPPER, LLP, P.O. BOX 877, BOISE, ID, 83701-0877, US

(21) Appl. No.: 11/424,417

(22) Filed: Jun. 15, 2006

(51) Int. Cl. A01K 13/00

(52) U.S. Cl. 119/850

(57) ABSTRACT

An animal garment for four-legged animals to protect such animals such as lambs and calves from cold and wet and to enhance their survivability. The garment is made up of connected halves and is adjustable along a portion that covers the back of the animal so as to allow for accommodation of the device to fit animals of different sizes or as an animal grows. The device includes holes for forelegs and detachable straps for hind legs, which hold the device in a secure position.

### FIELD OF THE INVENTION

The present invention generally relates to an apparatus for providing protection for animals, and more particularly to a clothing article for four-legged animals.

### BACKGROUND OF THE INVENTION

Newly born or very young animals often experience considerable loss of life, function, strength and vigor due to illnesses, such as pneumonia, scours and other infirmities which are brought on by a weakened condition caused in many instances by temperature change. Not only do these and other diseases cause the death of some young animals, it also causes entire groups of young animals to have reduced weight gain and increased disease problems.

A solution to this is to place a protective garment on young animals such as calves, lambs, goats, horses, and basically any four-legged animal. The protective garment should be constructed of a material that retains the animal's body heat, and keeps them warm when it is cold out. An alternative version of this garment could also have water replant or waterproof qualities, in order to help the young animal maintain its body warmth in rainy conditions.

A challenge for designing a garment for this purpose is that it must be able to remain on the animal for a considerable period of time without becoming ruined by urination and defecation. It must also be adjustable in size so that one coat can fit an animal as it grows.

### SUMMARY OF THE INVENTION

The present invention is an animal garment which is designed to be placed on young animals such as those mentioned above, and which helps them maintain their body heat, and this keeps them warmer in cold weather, and helps to keep them dry in wet weather, and thus helps to reduce disease and general health and increase weight gain. The garment can be made from a number of fabrics, depending on the particular goals of a farmer or rancher. Fabrics that have proven useful include polar fleece 200 and 300 weight, cordura nylon, rip stop nylon, and other materials. As in garments for humans, a whole range of synthetic fibers are available, all of which are useful in conserving body heat. These include polyester, nylon, chlorofiber, polypropylene, polyethylene, and such brand names as Polar Fleece, Polar Guard, and an entire range of other synthetic fabrics. Coated nylon allows any of these fabrics to be waterproof and windproof.

The animal garment of the invention addresses a problem that many young animals have with garments. When the animal urinates, if the garment is not open at the bottom, the garment becomes fouled with urine, and over time this causes the stitching and fabric of the garment to deteriorate and come apart. Also, if an animal garment is wet, it loses its ability to retain body heat, and causes the young animal to lose body heat by a rapid cooling of the wet garment as water evaporates.

To address the first problem, the animal garment of the invention is open at the bottom. The animal garment is made up of a right half and a left half, which have a top edge and a bottom edge, a front edge and a rear edge. The two halves are joined together along the front edge, which forms a seam which corresponds to the animal's chest area. The bottom seam which corresponds to the animal's chest area. The bottom seams of the garment are largely unattached to each other, so that the underside area is free and does not become fouled with urine from the animal.

Each of the sides of the garment includes a leg hole, which is designed to fit around the foreleg of the young animal. The rear of the garment does not have holes for legs. However, each half of the garment has an attached strap. The strap is at the rear edge of the garment half, and passes around the inside of the animal's rear leg, and then attaches to the half of the garment to which the other end of the strap is attached. Thus, the straps do not cross the midline of the body but stay on one side or the other of the animal's body. This has the advantage that for one thing, the straps don't get urinated on, and for another the straps don't cross over the young animal's navel and cause irritation or bleeding of the navel. Each of the garment halves includes an attachment means to which the free end of the strap attaches. This can be a hook and loop patch, which interacts with a hook and loop patch on the free end of the attachment strap, and secures the strap in place, which secures the garment in place.

Along the top edges of the garment are a number of attachment strips. These strips at the top edges are typically hook and loop strips, which attach to corresponding hook and loop strips on the top edge of the opposite half of the garment body. There are multiple strips of these hook and loop regions so that the garment can be adjusted for the size of the animal. By having this adjustment mechanism, one animal garment can be adjusted to fit a range of different sized animals. For instance a small garment might fit calves which are 37 pounds to 70 pounds, while a medium garment of the same design would be used on a calf of 70 pounds to 150 pounds, and the large garment will go from 80 to 175-200 pounds.

If an animal is exceptionally small for a particular garment, such as a 36 to 60 pound calf, the attachment strap can go up the side from which it originates, over the animal's back, and attach to the attachment means on the opposite side of the animal garment.

The animal garment can also be made of more than one layer, or with an outer layer which can be added or removed, depending on the weather conditions. For instance, during especially cold or wet weather a waterproof layer of coated nylon, Gore-Tex or other waterproof resistant material may be attached to the outside of a garment made of polar fleece or cordura. This extra layer of weather protection serves to extend the weather range that the garment would be beneficial in and further protecting the young animal. The outer covering of the outer waterproof covering which might be attached to the garment, can be a one-piece unit which drapes over the animal's back and attaches with a hook and loop or other fasteners to the animal garment of the invention.

Other types of fasteners which can be used in place of the hook and loop fasteners include buckles, snaps, buttons, a ring and hook, zippers, ties, or any other conventional means of attachment.

Alternative designs of the animal garment are possible, and are especially useful for animals such as goats. Goats are very flexible and can reach back and chew or bite straps which are attached to the outside of the garment. Thus, a version of the garment in which the securing strap attaches to the inside of the garment is preferable for goats, to prevent the goat from chewing on the strap, and thus destroying it.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a view of the right side of the animal garment of the invention.

FIG. 2 is a view of the left side of the animal garment of the invention.

FIG. 3 is a perspective view of the left side of the animal garment on the animal.

FIG. 4 is a side view of the right side of the animal garment on an animal.

### DESCRIPTION OF THE PREFERRED EMBODIMENTS

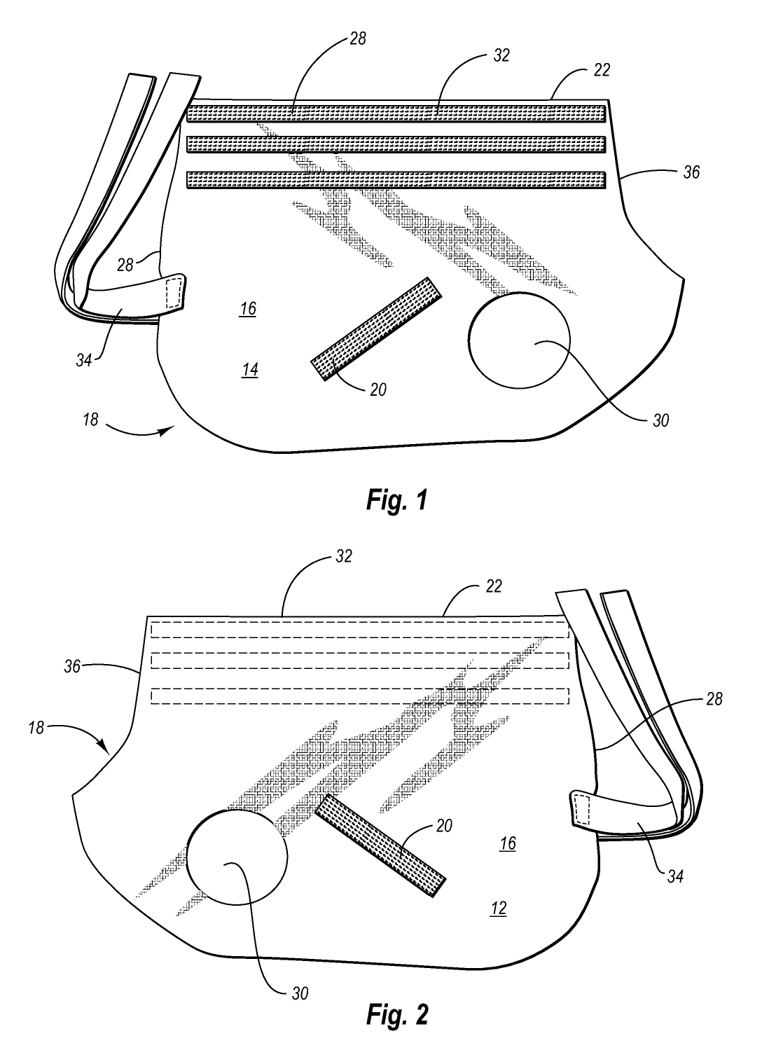

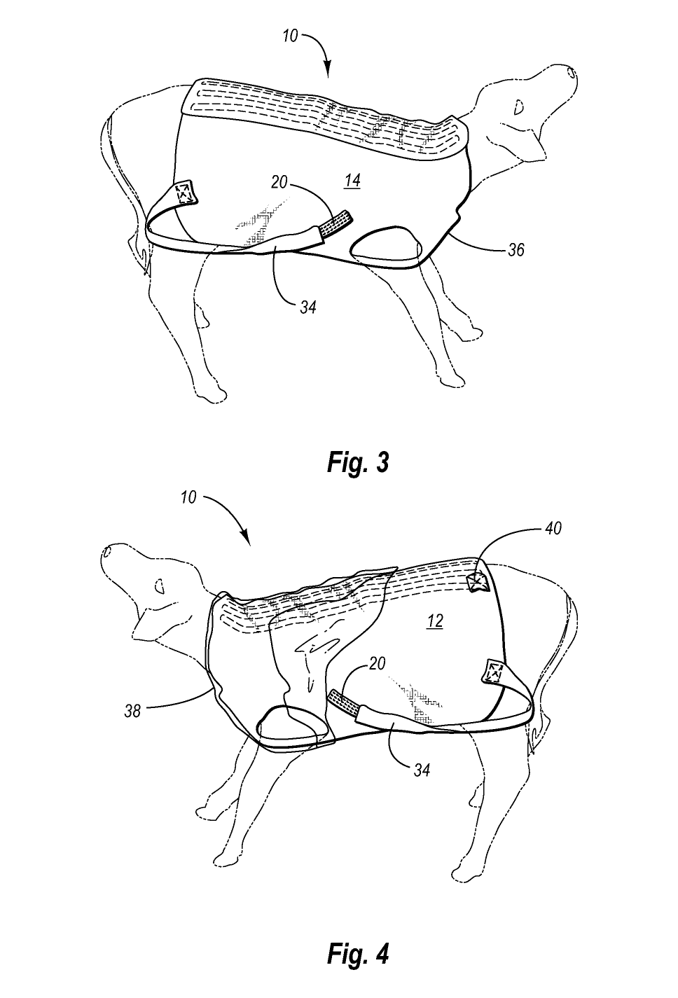

In one preferred embodiment of the invention the animal garment is made in two halves which are joined at various places. An example of the preferred embodiment of the present invention is shown in FIGS. 1-4 of the present application. FIG. 1 shows a left half and FIG. 2 shows a right half of the animal garment 10. FIGS. 3 and 4 show the placement of the present invention upon a young sheep with an undocked tail. While one type of animal is shown it is to be distinctly understood that the invention is not limited thereto but may be variously embodied to incorporate a variety of features and which may be used upon a variety of types of animals depending upon the particular situation confronted by a user.

The left half 12 shown in FIG. 1 has an exterior surface 16 and an interior surface 18. On the exterior surface 16 is mounted an attachment device 20, which in the configuration shown is a strip of hook and loop materials. The attachment device can also be configured for other attachment mechanisms such as buckle and strap, snaps, button and buttonhole, and any number of other conventional attachment systems. The left half 12 shown in FIG. 1 has a top edge 22 and a bottom edge 24. It also has a front edge 26 and a back edge 28. Defined in within the left side 12 is a leg hole 30 adjacent and parallel to the top edge 22 are a number of sealing strips 32 these are preferably formed from a hook and loop material. Along the back edge 28 is attached a securing strap 34.

Right half 14, as shown in FIG. 2, has similar features as the left half 12. The right half 14 has an exterior surface 16, an interior surface 18, attachment means 20, top edge 22, bottom edge 24, front edge 26, back edge 28, leg hole 30, securing strap 34, and sealing strips 32. The sealing strips on the right half are located on the interior surface 18 of the right half 14. Since they are on the interior surface of this half, they can extend over the back of an animal and interface with the sealing strips 32 which are located on the exterior surface of the left half 12. Since there are a number of sealing strips on at least one of the halves adjacent to the top edge 24, the left and right halves can be joined using any combination of the sealing strips. This allows the animal garment 10 to be adjusted for the size of an animal. As an animal grows the animal garment can be made to accommodate the larger size.

The left and right halves, 12 and 14, are joined along part of the bottom edge 24. In one configuration of the animal garment 10 the left and right half 12 and 14 are joined on only the front portion of the bottom edge 24. For instance they could be joined from a point adjacent to the leg hole 30 towards the front of the garment. They could also be joined adjacent the collar 36 by being sewn together or by connecting with a strap and buckle or a strap connection which utilizes hook and loop attachment.

The animal garment 10 of the invention can be augmented by a separate piece which is attachable to the exterior surface of the garment. This exterior piece is basically a rain covering 38, and adds the capability of being waterproof and windproof to the garment. An orientation marker 40 is optional and provides a reference to a person fitting a garment to an animal.

The garment can be made in quite a number of fabrics. A particular fabric which has proven very successful is polar fleece in either the 200 or 300 weight. The animal garment 10 can include a layer of polar fleece covered by an outer layer of cordura nylon for abrasion resistance, or rip stop nylon for being windproof and waterproof. The removable rain covering 38 would preferably be of a cordura nylon, such as corded rip stop nylon, but other materials are also suitable. Such materials include coated rip stop nylon, sylnylon, or Goreta, and other types of appropriate water resistant materials.

From the foregoing description, it will be apparent that various changes may be made without departing from the spirit and scope of the invention as defined by the following claims. The aforementioned describes the preferred embodiment of the invention and is not intended to be limiting in any way.

What is claimed is:

1. An animal garment, comprising:
a garment body, made up of a left half and a right half, each of the halves having a front edge and a back edge, a bottom edge and a top edge, the front edges being jointed and the bottom edges being at least partially unattached to one another, the top edges comprising a plurality of sealing strips for adjustably joining the two top edges over the back of an animal, each half of the garment defining a foreleg hole near the front edge of the half, the foreleg hole configured dimensioned to allow passage of an animal foreleg therethrough, each half also having a securing strap connected thereto in a position whereby an animal's rear leg may fit through an opening defined by the securing strap and the half of the garment body that the strap is connected to; and
an attachment device on each garment half, the attachment device configured to connect with a free end of the securing strap.

2. The animal garment of claim 1, in which the attachment strips are hook and loop type fastener strips that allow the top edges of the garment to be joined in a position to fit a particular animal.

3. The animal garment of claim 2 wherein with multiple attachment strips are connected to the garment thus allowing for a tailored fit for a range of animals of different sizes.

4. The animal garment of claim 1 wherein the bottom edges not joined at all, thus preventing fouling of the seam from animal urine.

5. The animal garment of claim 1 wherein the bottom edges are joined only at a front portion of a bottom seam and the remaining portions of the bottom edges are allowed to be free.

5. The animal garment of claim 1 wherein each of the two halves of material are made from a single piece of material.

6. The animal garment of claim 1 wherein each of the two halves are made from at least two pieces of material that have been joined together.

7. The animal garment of claim 1 wherein the attachment device is buckle that is configured to secure the securing strap.

8. The animal garment of claim 1 wherein the attachment device is snap type fastening device.

9. The animal garment of claim 1 further comprising an orientation indicator, to indicate which end of each of the halves is the front or back.

10. The animal garment of claim 9 wherein the orientation indicator is an attachment of a different color than the rest of the garment.

11. The animal garment of claim 9 wherein the orientation indicator is positioned upon the garment adjacent a rear edge.

12. The animal garment of claim 1 wherein the securing strap is dimensioned so as to allow this securing strap to pass inside the leg of the animal, up the side of the garment half from which the strap originated, and over the back of the animal to connect with the attachment device that is positioned on the opposite garment half, so as to allow the free end of the strap to be used on small animals without the strap passing over the region of the animal's navel.
